(19) United States
(12) Patent Application Publication
(10) Pub. No.: US 2024/0360964 A1
(43) Pub. Date: Oct. 31, 2024

(54) SPLIT-TYPE LAMP GROUP STRUCTURE

(71) Applicant: DONGLIN HE, Zhumadian (CN)

(72) Inventor: DONGLIN HE, Zhumadian (CN)

(21) Appl. No.: 18/140,991

(22) Filed: Apr. 28, 2023

(51) Int. Cl. F21K 9/235; F21V 19/00; F21V 23/00

(52) U.S. Cl. CPC F21K 9/235; F21V 19/0025; F21V 23/002; F21K 9/90

(57) ABSTRACT

The present application relates to the field of lighting technology, in particular to a split-type lamp group structure. Its technical solution includes: a split-type lamp group structure, comprising a base, an upper cover, a limiting seat and a lamp post, and a cover plate is arranged on a top end of the base, and the limiting seat is arranged inside the base, the lamp post is arranged at a bottom end of the limiting seat, and an outer cover of the lamp post is provided with a lamp housing, a wire is arranged inside the lamp post, a holder is provided on the wire, and a filament is connected to bottom end of the wire, a thimble is plugged into the limiting seat, and a cable is pressed and fixed on the limiting seat by the upper cover, and the thimble is in contact with a conductor of the cable.

### TECHNICAL FIELD

The present application relates to the field of lighting technology, in particular to a split-type lamp group structure.

### BACKGROUND

With the development of lighting technology, traditional incandescent lamps (tungsten filament lamps) are gradually being eliminated due to high energy consumption and short service life, and replaced by LED bulbs. The shape of the LED lamp bulb is similar to that of a traditional incandescent lamp bulb, and it adopts the existing traditional screw socket and socket connection method, which is in line with people's habit of using lamp bulbs. However, the existing LED lamp bulbs are cast in one piece. During the application process, once a problem occurs in one part of the LED lamp bulb, the whole lamp bulb is meant to be useless, thereby causing a serious waste of resources and greatly increasing the cost. This requires to design a novel split-type lamp group structure, which can realize the split combination of LED bulbs. When a problem occurs in one place, the application ability of the split-type lamp group structure can be improved through the split application.

### SUMMARY

The present application provides a split-type lamp group structure, which solves the above-mentioned technical problems.

The technical solution that the present application provided for solving the above-mentioned technical problems is as follows: a split-type lamp group structure, comprising a base, an upper cover, a limiting seat and a lamp post, and a cover plate is arranged on a top end of the base, and the limiting seat is arranged inside the base, the lamp post is arranged at a bottom end of the limiting seat, and an outer cover of the lamp post is provided with a lamp housing, a wire is arranged inside the lamp post, a holder is provided on the wire, and a filament is connected to bottom end of the wire, a thimble is plugged into the limiting seat, and a cable is pressed and fixed on the limiting seat by the upper cover, and the thimble is in contact with a conductor of the cable.

The beneficial effect of the present application is: when in use, the user places the cable in the second clamping slot of the limiting seat, and then the user puts the upper cover on the limiting seat so that the upper cover squeezes the cable downwards, so that the thimble pierces the rubber layer of the cable, so that the thimble contacts the conductor of the cable, so that the cable, the thimble, the wire and the filament form a loop, and the filament is turned on.

On the basis of the above technical solution, the following improvements can also be made to the present application.

Further, the upper cover is provided with limiting blocks, the limiting seat is provided with limit holes, and the upper cover is clamped and fixed with the limiting seat through the limit blocks and the limit holes.

The beneficial effect of using the above further solution is that it is convenient to assemble the upper cover and the limiting seat.

Further, through holes penetrating through the limiting seat are formed in the limiting seat, and the thimble penetrates through the through hole and contacts the wire.

The beneficial effect of using the above further solution is that it is convenient for the thimble to connect the cable with the wire.

Further, a first clamping slot and a second clamping slot are respectively provided on the upper cover and the limiting seat, and the upper cover and the limiting seat clamp and fix the cable through the first clamping slot and the second clamping slot.

The beneficial effect of using the above further solution is that it is convenient to limit the installation position of the cable, thereby solving the technical problem that the positive and negative electrodes are easily contacted and cause a short circuit.

Further, a lifting lug is provided on the cover plate.

The beneficial effect of using the above further solution is that it is convenient for the lamp bulb to be hung and placed through the lifting lug.

The above description is only an overview of the technical solution of the present application. In order to have a clearer understanding of the technical means of the present application and implement them according to the contents of the description, the preferred embodiments of the present application and accompanying drawings are described in detail below. The specific implementation manner of the present application is given in detail by the following examples and accompanying drawings.

### BRIEF DESCRIPTION OF DRAWINGS

The accompanying drawings described herein are used to provide a further understanding of the application and constitute a part of the application. The exemplary embodiments and descriptions of the present application are used to explain the present application, and do not constitute undue limitation to the present application.

In figures:

FIG. 1 is an appearance schematic diagram of the present application;

FIG. 2 is a sectional structural schematic diagram of the present application;

FIG. 3 is a schematic diagram of the front view of the holder of the present application;

FIG. 4 is a schematic diagram of the appearance of the thimble of the present application;

FIG. 5 is a schematic diagram of the appearance of the upper cover of the present application;

FIG. 6 is a schematic bottom diagram of the limiting seat of the present application viewed from the outside;

FIG. 7 is a schematic top view of the appearance of the limiting seat of the present application.

In the Figures, the list of parts represented by each label is as follows:
1. Base; 2. Cover plate; 3. Cable; 4. Lamp housing; 5. Filament; 6. Conductor, 7. Thimble; 8. Upper cover; 9. Limiting seat; 10. Holder; 11. Lamp post; 12. First clamping slot; 13. Limit block; 14, Through hole; 15. limit hole; 16. Second clamping slot.

### DETAILED DESCRIPTION

The principles and features of the application are described below in conjunction with the accompanying drawings. The examples given are only used to explain the application, and are not intended to limit the scope of the application. In the following paragraphs, the present application is described more particularly by way of example with reference to the accompanying drawings. The advantages and features of the present application will become more apparent from the following description and claims. It should be noted that the drawings are all in very simplified form and use imprecise scales, and are only used to facilitate and clearly assist the purpose of illustrating the embodiments of the present application.

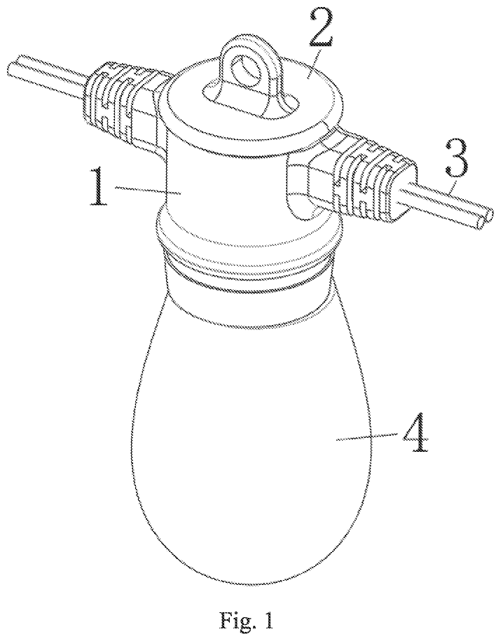

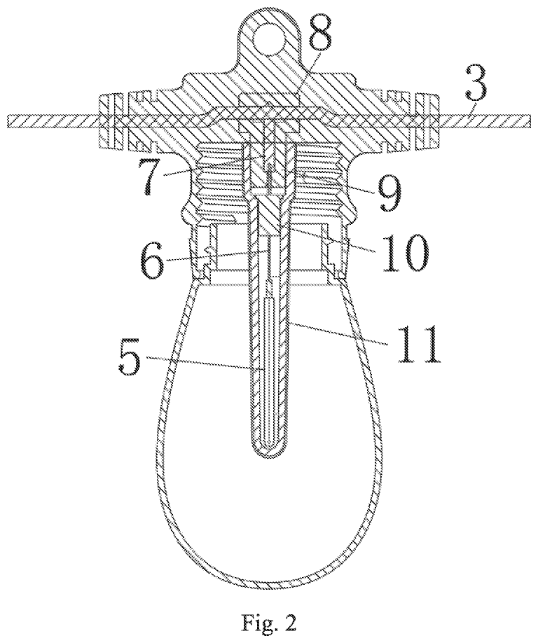

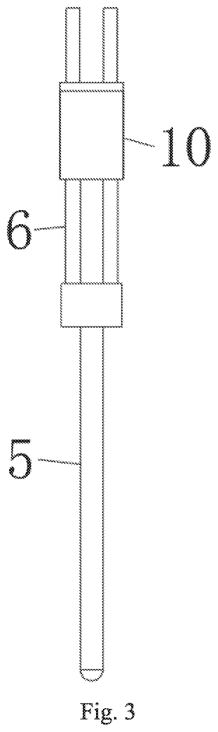

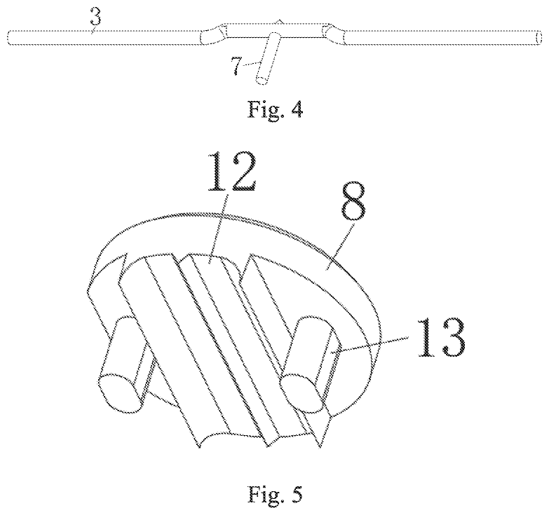

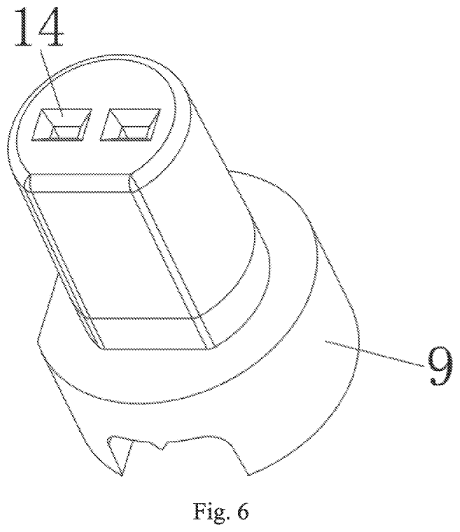

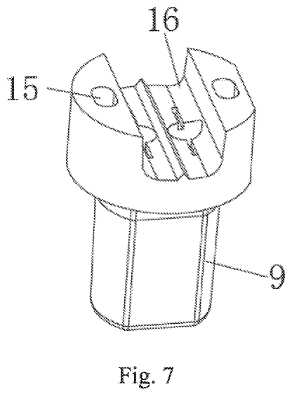

Please refer to FIG. 1 to FIG. 7, the embodiment that this application provides:

### Embodiment 1

A split-type lamp group structure, comprises a base 1, an upper cover 8, a limiting seat 9 and a lamp post 11, and a cover plate 2 is arranged on a top end of the base 1, the cover plate 2 is provided with a lifting lug and the limiting seat 9 is arranged inside the base 1, the lamp post 11 is arranged at a bottom end of the limiting seat 9, and an outer cover of the lamp post 11 is provided with a lamp housing 4, a wire 6 is arranged inside the lamp post 11, a holder 10 is provided on the wire 6, and a filament 5 is connected to bottom end of the wire 6, thimbles 7 are plugged into the limiting seat 9. The user places the cable 3 in the second clamping slot 16 of the limiting seat 9, and then the user puts the upper cover 8 on the limiting seat 9, so that the upper cover 8 squeezes the cable 3 downwards, so that the thimble 7 pierces the rubber layer of the cable 3, so that the thimble 7 contacts the conductor of the cable 3, so that the cable 3, the thimble 7, the wire 6 and the filament 6 form a loop, and the filament is turned on.

Through holes 14 penetrating through the limiting seat 9 are formed in the limiting seat, and the thimble 7 penetrates through the through hole 14 and contacts the wire 6. The limiting seat 9 is pressed and fixed with the cable 3 by the upper cover 8. A first clamping slot 12 and a second clamping slot 16 are respectively provided on the upper cover 8 and the limiting seat 9, and the upper cover 8 and the limiting seat 9 clamp and fix the cable 3 through the first clamping slot 12 and the second clamping slot 16. The upper cover 8 is provided with limiting blocks 13, the limiting seat 9 is provided with limit holes 15, and the upper cover 8 is clamped and fixed with the limiting seat 9 through the limit blocks 13 and the limit holes 15, and the thimble 7 is in contact with the conductor of the cable 3.

When using a split-type lamp group structure based on Embodiment 1: the user places the cable 3 in the second clamping slot 16 of the limiting seat 9, and then the user puts the upper cover 8 on the limiting seat 9, so that the upper cover 8 squeezes the cable 3 downwards, so that the thimble 7 pierces the rubber layer of the cable 3, so that the thimble 7 contacts the conductor of the cable 3, so that the cable 3, the thimble 7, the wire 6 and the filament 5 form a loop, and the filament is turned on.

The above is only a preferred embodiment of the application, and does not limit the application in any form. Those skilled in the art can smoothly implement the application as shown in the accompanying drawings and the above description; However, any equivalent changes, modifications and evolutions made by those skilled in the art without departing from the scope of the technical solutions of the present application by using the technical content disclosed above are equivalent embodiments of the present application. At the same time, any amendment, modification and evolution of any equivalent changes made to the above embodiments based on the substantive technology of the present application still fall within the protection scope of the technical solution of the present application.

What is claimed is:

1. A split-type lamp group structure, comprising a base (1), an upper cover (8), a limiting seat (9) and a lamp post (11), and a cover plate (2) is arranged on top end of the base (1), and the limiting seat (9) is arranged inside the base (1), the lamp post (11) is arranged at bottom end of the limiting seat (9), and an outer cover of the lamp post (11) is provided with a lamp housing (4), a wire (6) is arranged inside the lamp post (11), a holder (10) is provided on the wire (6), and a filament (5) is connected to bottom end of the wire (6), thimbles (7) are plugged into the limiting seat (9), and a cable (3) is pressed and fixed on the limiting seat (9) by the upper cover (8), and the thimbles (7) are in contact with a conductor of the cable (3).

2. The split-type lamp group structure according to claim 1, wherein the upper cover (8) is provided with limiting blocks (13), the limiting seat (9) is provided with limit holes (15), and the upper cover (8) is clamped and fixed with the limiting seat (9) through the limit blocks (13) and the limit holes (15).

3. The split-type lamp group structure according to claim 1, wherein through holes (14) penetrating through the limiting seat (9) are formed in the limiting seat, and the thimble (7) penetrates through the through hole (14) and contacts the wire (6).

4. The split-type lamp group structure according to claim 1, wherein a first clamping slot (12) and a second clamping slot (16) are respectively provided on the upper cover (8) and the limiting seat (9), and the upper cover (8) and the limiting seat (9) clamp and fix the cable (3) through the first clamping slot (12) and the second clamping slot (16).

5. The split-type lamp group structure according to claim 1, wherein a lifting lug is provided on the cover plate (2).
